(19) United States
(12) Patent Application Publication
(10) Pub. No.: US 2014/0127950 A1
(43) Pub. Date: May 8, 2014

(54) ELECTRICAL CONNECTOR

(71) Applicant: HON HAI PRECISION INDUSTRY CO., LTD., New Taipei (TW)

(72) Inventors: AI-HONG FANG, Kunshan (CN); I-FAN YEN, New Taipei (TW); HUO-XING JIN, Kunshan (CN)

(21) Appl. No.: 13/909,111

(22) Filed: Jun. 4, 2013

(30) Foreign Application Priority Data
Nov. 2, 2012 (CN) 201220572229.9

(51) Int. Cl. H01R 13/405

(52) U.S. Cl. CPC H01R 13/405
USPC 439/676

(57) ABSTRACT

An electrical connector comprises an insulative housing and a plurality of conductive terminals fixed to the insulative housing. The insulative housing includes a pair of longer walls and a pair of short walls bounding a plug-receiving cavity with an insertion direction. The conductive terminals include plate portions partly embedded in inner surfaces of the longer walls and welded portions extending out of the insulative housing. The inner surface of the longer walls define Positioning grooves between every adjacent terminals. Each of the plate portion of the conductive terminal defines a contacting surface faced to the plug-receiving cavity and two side edges intersecting with the opening edge of corresponding Positioning groove. The structure of the connector contributes to an insert molding of the connector. It is convenient not only to terminal implant and but also to a precise positioning of two directions of the terminals during the insert molding process.

### BACKGROUND OF THE INVENTION

1. Field of the Invention

The present invention relates to an electrical connector, and more particularly to an electrical connector with a new insert-molding method for terminal retaining.

2. Description of the Related Art

U.S. Pat. No. 6,010,370 issued on Jan. 4, 2000, issued to Molex Incorporated. discloses an electrical connector including: an insulative housing, and a plurality of conductive terminals fixed to the housing. The housing defines a pair of long walls and a pair of short walls bounding a plug-receiving cavity with an insertion direction. The said terminals are arranged with a predetermined distance on the side surfaces and the upper surfaces along a longitudinal direction of the housing. Each terminal defines a solder portion, a connecting portion and a base portion connecting with the solder portion and the connecting portion. Both the long walls have a plurality of rectangle grooves between every two adjacent terminals, and the connecting portions are set in the grooves. Since the grooves are rectangle-shaped, it is hard to position the terminals into the grooves before the insert-molding process and it is not benefit to demoulding.

Therefore, an improved electrical connector is desired to overcome the disadvantages of the related arts.

### BRIEF SUMMARY OF THE INVENTION

An object of the present invention is to provide an electrical connector which is easier to position terminals during forming the connector by a insert-molding process.

In order to achieve above-mentioned object, an electrical connector including an insulative housing, a plurality of conductive terminals fixed to the insulative housing. The insulative housing defines a pair of long walls and a pair of short walls bounding a plug-receiving cavity with an insertion direction. The conductive terminals include plate portions partly embedded in inner surfaces of the long walls and welded portions extending out of the insulative housing. The inner surfaces of the longer walls define positioning grooves between every adjacent terminals. Each of the plate portion of the conductive terminal defines a contacting surface faced to the plug-receiving cavity and two side edges intersecting with the opening edge of corresponding positioning groove.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a perspective view of an electrical connector in accordance with the present invention;

FIG. 2 is a partially exploded perspective view of the electrical connector shown in FIG. 1;

FIG. 3 is a cross sectional view taken along the line 3-3 shown in FIG. 1;

FIG. 4 is a cross sectional view taken along the line 4-4 shown in FIG. 1;

FIG. 5 is a perspective view of the connector, wherein the upper half part is cut away along the line 5-5 shown in FIG. 1;

FIG. 6 is a top view of the electrical connector shown in FIG. 5; and

FIG. 7 is a partially enlarged view of the electrical connector circled in FIG. 2.

### DESCRIPTION OF PREFERRED EMBODIMENT OF THE INVENTION

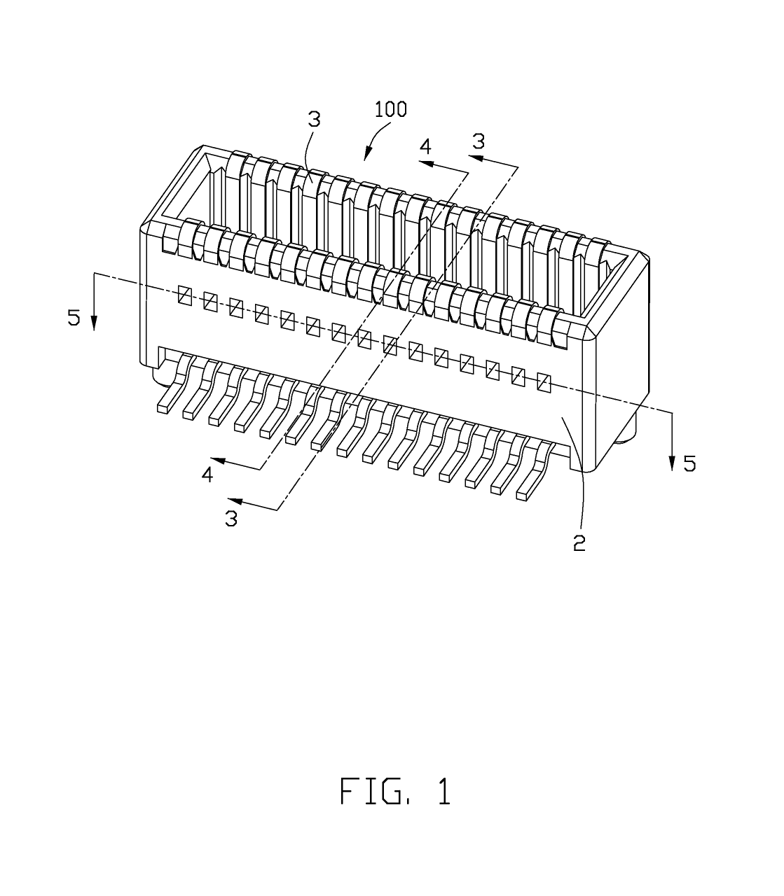

Reference will now be made to the drawing figures to describe a preferred embodiment of the present invention in detail. Referring to FIGS. 1 illustrates an electrical connector 100, the electrical connector 100 includes an insulative housing 2, and a plurality of conductive terminals 3 embedded in the insulative housing 2. The invention introduces a new way for the terminals' positioning, and it is easy to manufacture the electrical connector.

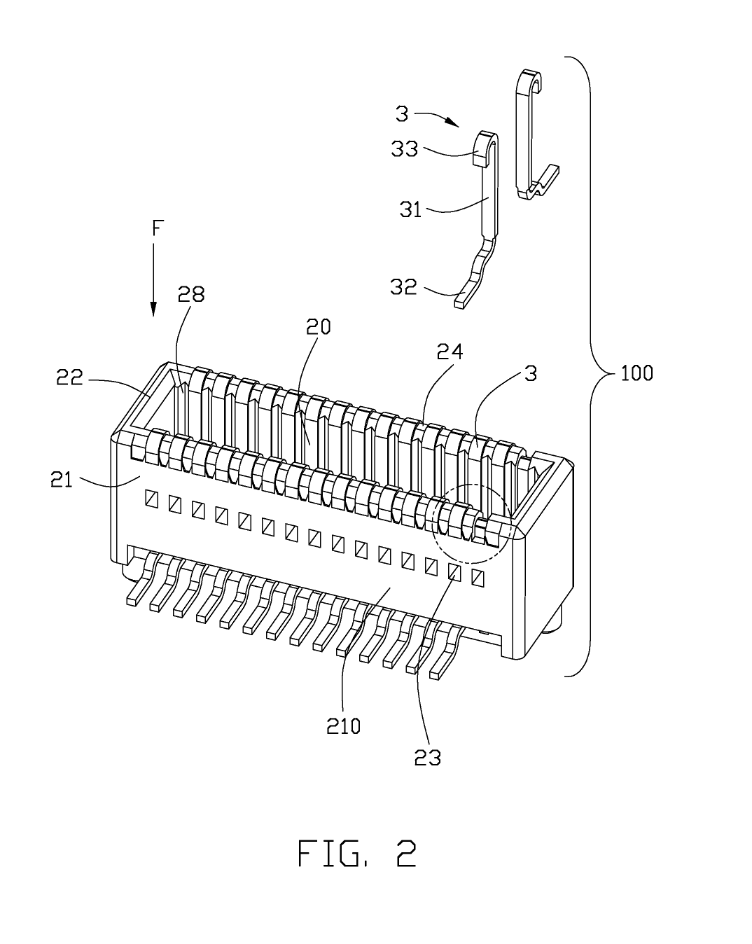

Referring to FIGS. 2 to 4, the insulative housing 2 is made from insulative material, such as plastic, etc., by injection molding process, and comprises a pair of side walls or long walls 21, and a pair of end walls or short walls 22 laterally connecting with the long walls 21. And a plurality of holes 23 run through the outer surfaces 210 of the long walls 21 and arranged corresponding to the terminals 3 one by one.

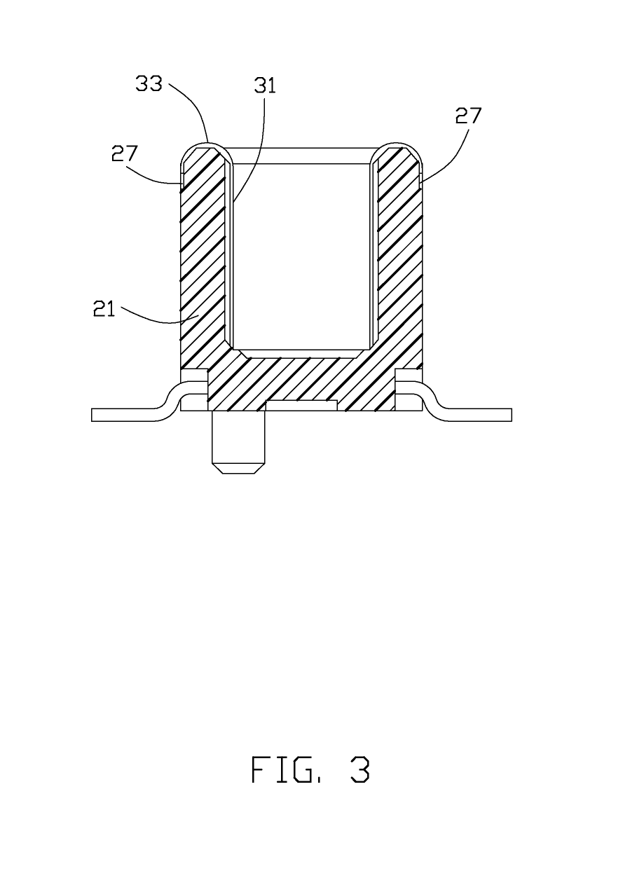

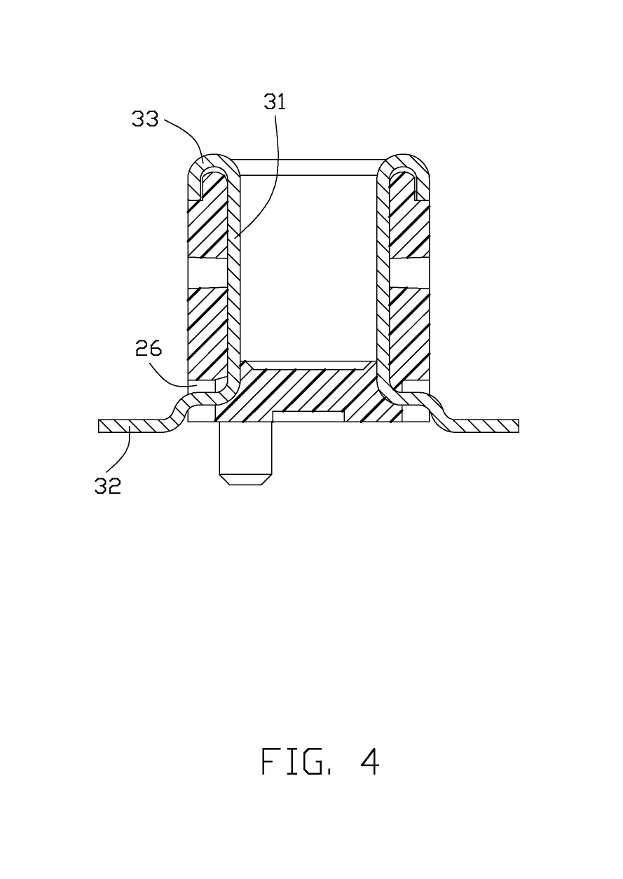

The long walls 21 and the short walls 22 define a plug-receiving cavity 20 thereamong with an insertion direction F. The plug-receiving cavity 20 defines inner surfaces where the terminals are located. Please notes, the housing 2 is shaped by an insert-molding method. The manufacture procedure can be realized as follows. Firstly, the plurality of terminals 3 is stamped and formed with a predetermined shaped. Secondly, the terminals 3 are pre-positioned into a cavity mold and then the melted insulative material is injected into the cavity mold. Finally, the mold core is spared from the mold cavity after the terminals 3 and the housing 2 are cooled down. Therefore, the electrical connector 100 is shaped. Each terminal 3 defines a plate portion 31 partially embedded into the inner surface of the long wall 21, and a welded portion 32 extending from the lower end of the plate portion 31 out the housing 2. A head portion 33 extending from the upper end of the plate portion 31, bends outward so as to be constructed on the upper surface 24 of the long wall 21 and extends to the outer surface 210 of the long wall 21. The head portions 33 are aligned with the holes 23 one by one and located over the holes 23 in a vertical direction of the electrical connector 100. The plate portions 31 of the terminals 3 are at least partially embedded in the long walls 21 and partially expose to the plug-receiving cavity, and the holes 23 are aligned with the corresponding plate portions 31 (as best shown in FIG. 3 and FIG. 4).

Scoop portions 26 are shaped adjacent to the welded portions 32 at the outer surfaces 210 of the long walls 21, which are shaped due to extraction of the mold core. The welded portions 32 are bended three times from the lower end of the plate portions 31. The upper parts of the welded portions 32 are located in the long walls 21 and the lower parts of the welded portions 32 extend out of the housing 2.

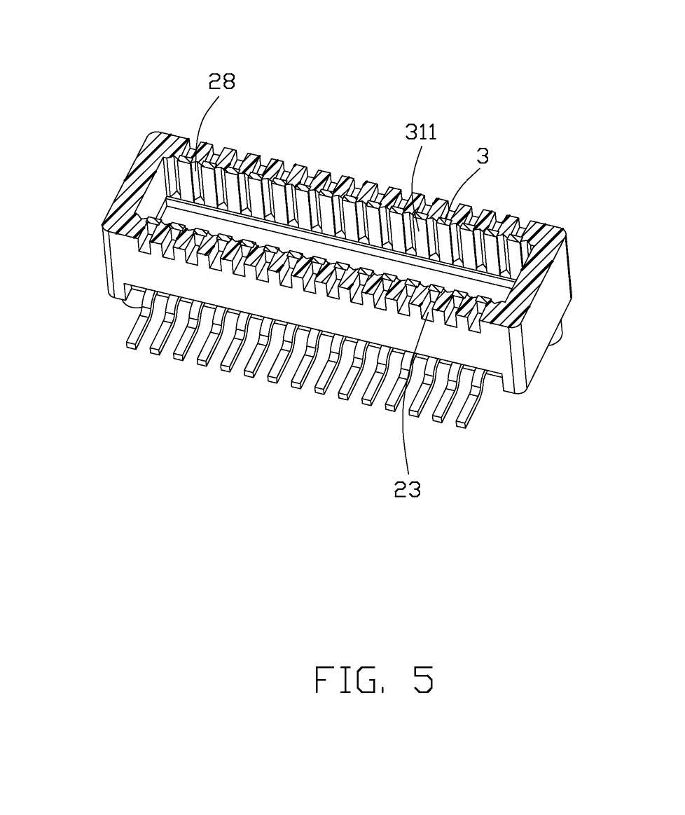

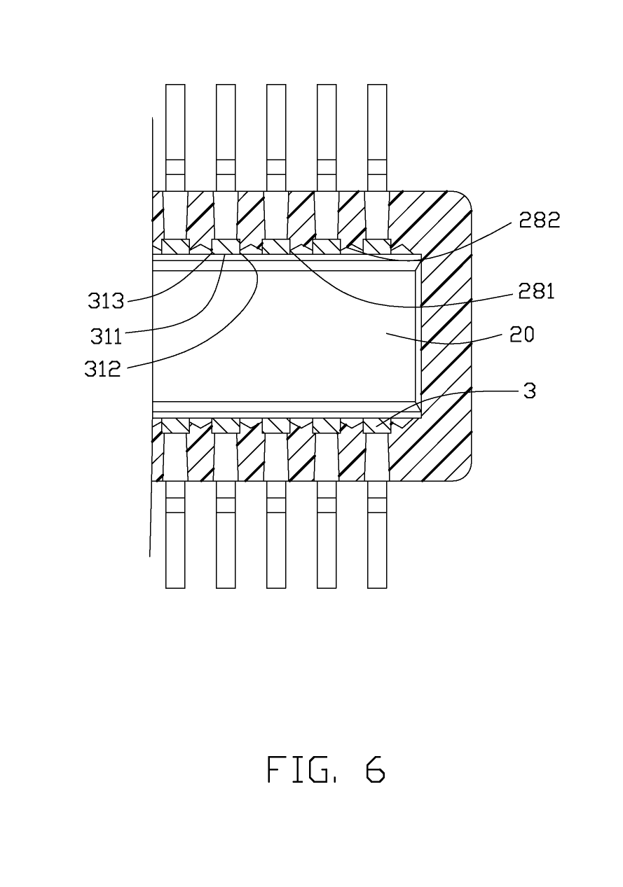

Referring to FIG. 5 to FIG. 6, a plurality of positioning grooves 28 are formed on the inner surface of the longer walls 21. The positioning grooves 28 extend parallel to terminals 3 and are located between two adjacent terminals 3. The positioning grooves 28 are formed after the mold core for terminals positioning is extracted from the cavity mold. The surfaces exposing to plug-receiving cavity 20 of the plate portions 31 are defined as contacting surfaces 311, each contacting surface 311 defines two opposite side edges 312, 313 which are intersecting with the opening edges 281 of each positioning groove 28. During the procedure of the manufacture, the portions of the mold core in positioning grooves 28 are resisting against two opposite side edges 312, 313 of the terminals 3, so that the positioning of terminals 3 in a contacting arrangement direction or longitudinal direction can be acquired. The portions of the mold core inserted into the positioning grooves 28 limit every two adjacent terminals 3 in the longitudinal direction. As understandably from the drawings, since the mold core is composed with a plurality of inverted V-shape, the positioning grooves 28 are in an V shape corresponding to the mold core. A distance between two adjacent tip points of inverted V-shape of the mold core is larger than that between two adjacent valley points of the mold core, which make it easier to put the terminals 3 into the mold core. In a preferred embodiment, the side edges 312, 313 of the terminals protrude into the plug-receiving cavity 20 beyond the opening edges 281 of the positioning grooves 28, which benefits in the implantation and embedment of the terminals into the cavity mold. Each positioning groove 28 defines two incline surfaces 282 intersecting at one tip line, the opening edge 281 is formed at the side of each incline surface 282. The distance between the opening edges 281 of two incline surfaces 282 of one positioning groove 28 equals to the distance between two adjacent terminals 3. The positioning grooves 28 are parallel to the insertion direction F, and run upwardly through the upper surface 24 of the long walls 21 and extend downwardly over the bottom surface of the plug-receiving cavity 20. The plate portions 31 of the terminals 3 project beyond the opening edges 281 of positioning grooves 28.

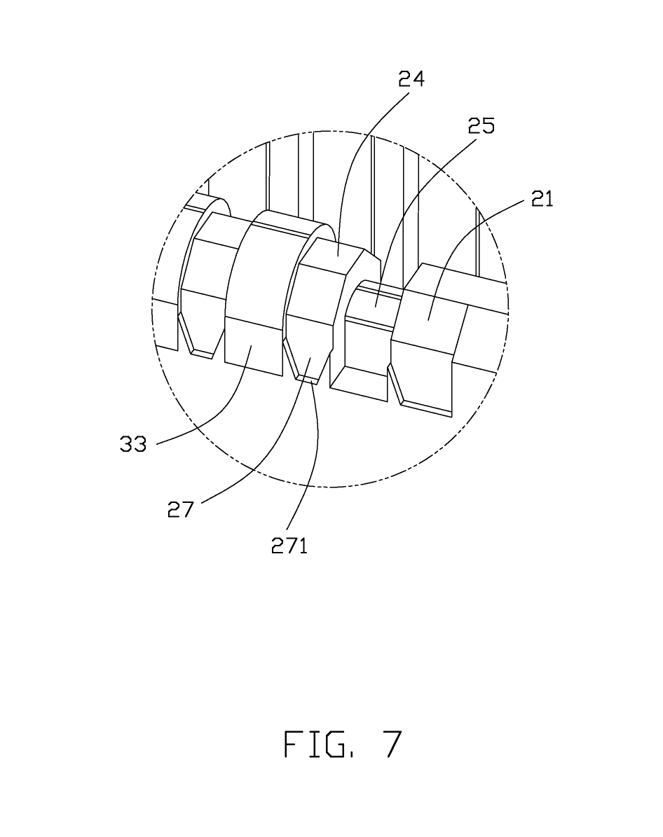

Referring to FIG. 3 and FIG. 7, part of the head portion 33 of the terminal 3 is embedded into the longer walls 21, and part is protruding out of the upper surface 24 of the long wall 21. A plurality of terminal passageways 25 are left when terminals 3 are removed. Grooves 27 are left on the outer surfaces of the long walls 21 between every two adjacent terminal passageways 25 after mold core is removed from the cavity mold, and the groove 27 is V-shaped. The grooves 27 run through the upper surface 24 of the long walls 21 and define bottom surfaces 271 which are flush with the ends of the head portions 33 of the terminals 3. From the direction parallel to the short wall, the ends of grooves 27 are Ladder-shaped, the ends of terminal recesses 25 are rectangle-shaped, and the width of the bottom surface 271 is smaller than the distance between the side edges of adjacent terminals 3.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the board general meaning of the terms in which the appended claims are expressed.

What is claimed is:

1. An electrical connector, comprising:
an insulative housing including a pair of long walls and a pair of short walls defining a plug-receiving cavity thereamong, the plug-receiving cavity defining an insertion direction and inner surfaces along the long walls;
a plurality of conductive terminals embedded along the long walls, the conductive terminals including plate portions embedded in the inner surfaces and welded portions extending out of the insulative housing, the plate portions defining two side edges and contacting surfaces facing to the plug-receiving cavity; wherein
the inner surfaces defining positioning grooves between every two adjacent terminals in a terminal arrangement direction perpendicular to the insertion direction, the positioning groove defines two opening edges facing to the plug-receiving cavity, the two side edges of the plate portions intersect with the opening edges of corresponding positioning grooves.

2. The electrical connector as described in claim 1, wherein the side edges of terminals protrude toward the plug-receiving cavity beyond the opening edges of the positioning grooves.

3. The electrical connector as described in claim 1, wherein each positioning groove is V-shaped and defines two incline surfaces intersecting with one line, the V-shaped positioning grooves define the said opening edges.

4. The electrical connector as described in claim 1, wherein a distance between every two adjacent terminals is equal to a distance between the opening edges of each positioning groove.

5. The electrical connector as described in claim 1, wherein the positioning grooves extend in the insertion direction and, run through upper surfaces of the long walls and downwardly toward a bottom surface of the plug-receiving cavity, the positioning grooves are located over the bottom surface of the plug-receiving cavity.

6. The electrical connector as described in claim 1, wherein a plurality of holes run through outer surfaces of the longer walls and are aligned with the plate portions of terminals one by one.

7. The electrical connector as described in claim 1, wherein the terminals comprise head portions extending opposite to the welded portions, the head portions bends outward and are constructed on the upper surfaces of the longer walls, the head portions are aligned with the holes one by one in a vertical direction.

8. The electrical connector as described in claim 1, wherein the housing defines a plurality of terminal passageways and a plurality of grooves between every two adjacent terminal passageways, from the direction parallel to the short walls, the terminal passageways are rectangle-shaped, and the grooves are Ladder-shaped.

9. The electrical connector as described in claim 7, wherein both the terminals passageways and grooves are disposed along the outer surface of the longer walls, and run through the upper surfaces of the longer walls, the terminals define head portions opposite to the welded portions, the head portions are embedded in the terminal passageways partially protruding out of the upper surfaces of the longer walls.

10. An electrical connector, comprising:
an insulative housing including a pair of side walls and a pair of end walls defining a plug-receiving cavity thereamong, the plug-receiving cavity defining inner surfaces along the side walls;
a plurality of conductive terminals embedded along the side walls, the conductive terminals including plate portions embedded in the inner surfaces and welded portions extending out of the insulative housing, the plate portions defining contacting surfaces facing to the plug-receiving cavity and two side edges perpendicular to the contacting surfaces; wherein
the inner surfaces defining positioning grooves between every two adjacent terminals in a terminal arrangement direction under a condition that the side edges of adjacent terminals face to each other directly in the terminal arrangement direction.

11. The electrical connector as described in claim 9, wherein the positioning grooves are made in a V shape.

12. An electrical connector comprising:
an insulative housing including a pair of longitudinal wall and a pair of transverse wall to commonly define therein an elongated plug-receiving cavity along a longitudinal direction, each of said longitudinal wall defining an interior surface facing toward the plug-receiving cavity in a transverse direction perpendicular to said longitudinal direction, said plug-receiving cavity upwardly communicating to an exterior in a vertical direction perpendicular to both said longitudinal direction and said transverse direction;
two rows of contacts disposed in the housing with contacting sections extending along the vertical direction on the corresponding interior surfaces, respectively, each of said contacting sections defining a candy-cane configuration viewed in the longitudinal direction with thereof an upper portion defining an upside-down U-shaped configuration straddling an upper ledge of each of the longitudinal walls with a tip region exposed upon an exterior surface of the corresponding longitudinal wall; and
each of said contacting sections defining thereof a thickness, along said transverse direction, of which a portion is hidden under the interior surface and the exterior surface of the corresponding longitudinal wall; wherein
each of said longitudinal walls defines a plurality of grooves, in the corresponding interior surface, each of said grooves located between two corresponding contacting sections of the corresponding adjacent two contacts;
wherein
two opposite side edges of the contacting section of each of said contacts, which are partially exposed upon the corresponding interior surface and to the exterior, face respectively toward the neighboring grooves in generally the longitudinal direction.

13. The electrical connector as claimed in claim 12, wherein a depth of said groove is not less than the thickness of the contact.

14. The electrical connector as claimed in claim 12, wherein the upper region of each of the grooves extends over the upper ledge and terminates at an upper area of the exterior surface.

15. The electrical connector as claimed in claim 14, wherein an end of said groove defines a V-shaped configuration.

16. The electrical connector as claimed in claim 12, wherein said groove defines a V-shaped cross-section.

17. The electrical connector as claimed in claim 12, wherein a distal tip of the contacting section of each of said contacts is fully embedded under the exterior surface in both vertical direction and said longitudinal direction.
